(19) United States
(12) Patent Application Publication
(10) Pub. No.: US 2002/0094304 A1
(43) Pub. Date: Jul. 18, 2002

(54) High speed liquid deposition apparatus for microarray fabrication

(76) Inventors: Tom Yang, Cupertino, CA (US); Yaping Zong, San Jose, CA (US); Stephen Bliss, Sunnyvale, CA (US)

Correspondence Address: AMERSHAM BIOSCIENCES, PATENT DEPARTMENT, 800 CENTENNIAL AVENUE, PISCATAWAY, NJ, 08855, US

(21) Appl. No.: 10/029,737

(22) Filed: Dec. 21, 2001

Related U.S. Application Data
(60) Provisional application No. 60/257,556, filed on Dec. 22, 2000.

(51) Int. Cl. B01L 3/02

(52) U.S. Cl. 422/100

(57) ABSTRACT

An apparatus for dispensing a liquid includes a dispensing end, an adaptor end, and an elongate dispenser body extending therebetween. The dispenser body has a first major surface extending to the dispening end. The dispenser body defines a fluid reservoir opening on the first major surface for receiving a fluid to be dispensed. The dispenser body also defines a first elongate open channel opening on the first major surface and extending between the fluid reservoir and the free end of the dispenser body. The first channel includes dimensions such that the fluid to be dispensed is conducted through the channel by capillary action.

### FIELD OF THE INVENTION

The instant disclosure pertains to an apparatus useful for depositing small amounts of substances onto a substrate. In particular, this disclosure pertains to an apparatus for depositing small amounts of biomolecules such as nucleic acid fragments onto a substrate to form a microarray.

### BACKGROUND OF THE INVENTION

Biological microarrays may be used to examine gene activity and to identify gene mutations. Microarrays are formed by depositing biological material such as nucleic acid fragments in a pattern on a substrate such as a glass microchip. After a hybridization reaction between the nucleic acid sequences on the microarray and a fluorescently labeled nucleic acid sample, the chips may be read with high-speed fluorescent detectors and the intensity of each spot quantified. The location and intensity of each spot reveals the identity and amount of each nucleic acid sequence present in the sample. Because tens of thousands of gene fragments may be present on a single micro array, data for entire genomes may be acquired in a single experiment.

The quality of the micro array greatly influences the quality of the data obtained using microarray analysis. For example, arrays having uniform spot size provide uniform signal intensities at each pixel and result in data having greater precision. Uniform spot size is also an indication that an equal amount of array material (e.g., DNA, RNA, protein, etc.) is present across the entire spot, thus ensuring that the binding of labeled sample to array sequences will occur at the same rate across the spot. Also desirable is the ability to create a regular array pattern capable of being consistently reproduced multiple times on multiple substrates. These qualities are dependent on the means used for depositing the array material onto the substrate.

Although the typical volume transferred in creating microarray spots is in the sub-nanoliter (10⁻⁹L) or picoliter (10⁻¹²L) range, it is becoming more conventional to refer to the spot diameter which may be in the range of about 220 μm to about 100 μm. Known techniques for manually transferring fluids are not able to deposit the large number of spots in this volume/diameter range in a reasonable time and therefore are not practical for creating microarrays for use in high-through-put nucleic acid analysis. As a result, attention has been directed to other technologies, such as photolithographic techniques involving the in situ synthesis of oligonucleotides on a substrate, and ink-jet and contact printing techniques for depositing biological materials on substrates.

Photolithographic techniques involving the in situ synthesis of oligonucleotides on a substrate are generally limited to short oligonucleotides (e.g., approximately 30 bases or less in length). Moreover, in situ synthesis of oligonucleotides is limited to oligonucleotides of known nucleic acid sequence. Thus, it is not possible to use such arrays to study unknown nucleic acid sequences. Furthermore, the equipment and techniques necessary for photolithographic in situ oligonucleotide synthesis are more commonly used in the semiconductor industry rather than the average biotech lab. Expense of the equipment required and the intricacies of the method make it difficult for the average biotechnology lab to create custom arrays using photolithographic techniques. Thus, researchers are limited to purchasing photolithographic arrays containing standard oligonucleotide sequences from companies having the facilities and technical expertise for mass production of the same.

Non-contact dispensing techniques such as ink-jet printing involve the ejection of drops from a dispenser onto a substrate. In ink-jet printing, the drops are ejected from the dispenser using either a piezoelectric crystal which deforms in response to a voltage and squeezes the fluid from the dispenser, or a syringe pump coupled to a high speed solenoid valve. Early ink jet dispensers consumed large amounts of sample. While this problem has for the most part been addressed, present ink jet dispensers continue to have difficulty with viscous samples which can causing clogging of print heads. Also, many ink jet designs contain crevices which are difficult to wash and result in cross-contamination of samples resulting in false signals. Furthermore, ink jet printers require a number of parts which contribute to the overall expense of this technique.

Contact printing involves the use of rigid pin tools, also referred to as “pens,” which are dipped into the sample solution, resulting in the transfer of small volumes of fluid onto the tip of the pins. Microarray spots are created by touching the pins or pin samples onto the surface. Such pin tools can be solid pins or capillaries, tweezers, and split pins that hold larger sample volumes than solid pins. For example, U.S. Pat. No. 5,807,522 to Brown et al. discloses one such device having an elongate capillary channel formed by spaced-apart, coextensive elongate members, adapted to hold a quantity of the reagent solution and having a tip region at which aqueous solution in the channel forms a meniscus. The device is loaded by dipping the capillary channel in reagent and spots are created on a substrate by tapping the tip against the substrate with an impulse effective to break the meniscus in the capillary channel and deposit a selected volume on the substrate.

Another pen variation disclosed by U.S. Pat. No. 5,770,151 to Roach et al. teaches a microspot deposition system featuring a hollow cylindrical wall extending from a closed end, terminating in an open end and including a longitudinal gap extending from the open end toward the closed end. The cylindrical wall defines a lumen with both the lumen and the gap adapted to facilitate capillary action of liquid in fluid communication therewith to form a meniscus proximate to the open end. The gap may be tapered to facilitate deposition of the liquid onto the substrate.

Yet another pen variation includes the Pin and Ring (PAR) technique which involves dipping a small ring into the sample well and removing it to capture liquid in the ring. A solid pin is then pushed through the sample in the ring and sample trapped on the flat end of the pin is deposited onto the surface.

Although contact printing is relatively less expensive compared to the techniques for depositing biological materials on substrates described above, such pens typically require micro-machining and are both labor intensive and expensive to manufacture. For example, multiple pens (e.g., typically as many as 48 or more) are necessary to simultaneously create spots for high throughput microarray manufacture. Such pen sets should be matched to ensure uniform spot formation. In addition, as microarray technology evolves, smaller spots will be required to increase the density of the arrays.

As the above discussion suggests, improvements are still possible and desirable in the area of depositing small amounts of biomolecules to create microarrays for use in high-through-put analysis. For example, an apparatus is needed to deposit smaller volumes/smaller spots of substances to create higher density microarrays. An apparatus should also deposit spots having a uniform size. In particular, such an apparatus should create a regular array pattern capable of being consistently reproduced multiple times on multiple substrates. Preferably, such an apparatus would be inexpensive and relatively easy to manufacture. Preferably, it should be possible to manufacture such an apparatus with minimal variation so as to simplify the creation of matched pen sets necessary to simultaneously create spots for high throughput microarrays. These and other points are addressed in greater detail in the following disclosure.

### SUMMARY OF THE INVENTION

In view of the needs of the prior art, the present invention provides an apparatus for dispensing a liquid which is easy to manufacture and maintain. The dispensing apparatus of the present invention requires a very light contact force between with a substrate so as to reduce wear and tear associated with dispensing a fluid. The present invention provides a dispensing pen for dispensing a liquid that includes a dispensing end, an adaptor end, and an elongate dispenser body extending therebetween. The dispenser body includes a first major surface extending to the free end of the dispenser body. The dispenser body defines a fluid reservoir opening on the first surface for receiving a fluid to be dispensed. The dispenser body also defines a first elongate open channel opening on the first major surface and extending between the fluid reservoir and the free end of the dispenser body. The first channel includes dimensions such that the fluid to be dispensed is conducted through the channel by capillary action.

The present invention further provides an apparatus for dispensing a liquid including a plurality of dispensing pens having a liquid to be dispensed when brought towards a surface. The pens are retained by a dispensing pen manifold having a plurality of cantilever arms for independently supporting the plurality of dispensing pens.

The present invention still further provides a pen for dispensing a liquid having an elongate planar dispensing body and a first free end including a strike tip. The dispensing body also defines a fluid reservoir for receiving a fluid to be dispensed and an open fluid channel for conducting the fluid to be dispensed between said strike tip and the fluid reservoir.

The substantially planar dispense pens of the present invention are particularly suited for mass production using processes well-known for fabricating flat metallic components. For example, a 1 to 1 computer-generated photomask may be used in a photochemical machining process. Typically, identical pen images attached to a frame image of a part to be fabricated are nested together on a working size sheet of artwork from which several hundred pens can be processed at one time on each sheet of material. The pens are fabricated using double sided etching so there is a top and a bottom photomask which are precision aligned to each other. A photoresist film is applied to both sides of the material sheet to be etched. The two photomasks are then applied to each side of the material sheet and the entire structure is then exposed to ultraviolet light. The material is then dipped into a developing solution to wash away the unexposed portion of the photoresist. The sheet is then run through a spray type etching machine, which chemically etches away the unprotected image, leaving behind a plurality of pen body preforms, corresponding to the pen images attached to the frame image. High volume fabrication of microarray spotter pens is therefore achieved in a more economical.

### BRIEF DESCRIPTION OF THE SEVERAL OF THE VIEWS OF THE DRAWINGS

FIG. 1 is a perspective view of an apparatus for dispensing fluid of the present invention.

FIG. 2 is a perspective view of the dispensing end of the apparatus of FIG. 1.

FIG. 3 is a perspective view of the dispensing tip of the apparatus of FIG. 1.

FIG. 4 is a perspective view of the dispensing tip of an alternate embodiment of the present invention having a pair of opposed channels from the reservoir.

FIG. 5 is a perspective view of yet another embodiment of the present invention having a pair of opposed channels and a pair of opposed reservoirs.

FIG. 6 is a perspective view of the dispensing tip of still yet another embodiment of the present invention having a central through-channel formed in the tip.

FIG. 7 is a 1:1 scale photomask generated from a computer model in which identical images of the apparatus may be formed.

FIG. 8 is a perspective view of a first embodiment of a pen-holder assembly of the present invention containing twelve pens.

FIG. 9 is an elevated view of still another embodiment of the present invention having a shock absorbing spring formed in one end of the apparatus.

FIG. 10 is a perspective view of a block manifold assembly for accommodating the apparatus of FIG. 9.

### DETAILED DESCRIPTION OF THE PREFERRED EMBODIMENT

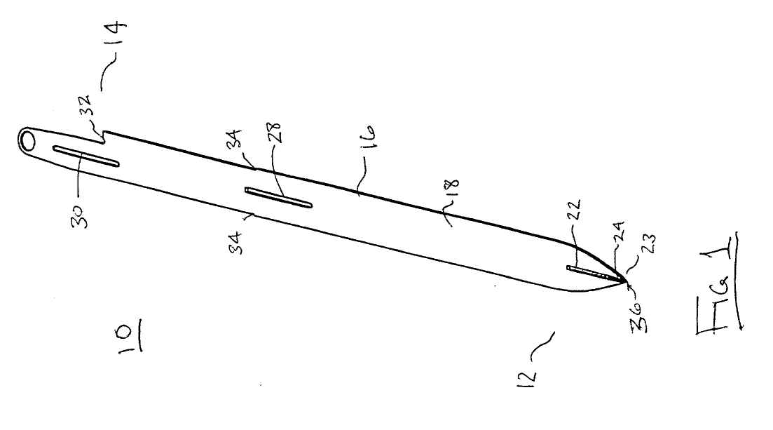

FIG. 1 depicts a dispensing pen 10 of the present invention. Pen 10 includes a dispensing end 12, an opposed adaptor end 14, and an elongate pen body 16 extending therebetween. Pen 10 is particularly suited to dispense spots of sub-nanoliter volumes of DNA or biomolecules to create microarrays for use in high-through-put analysis. Pen body 16 is desirably fabricated by a photochemical machining process commonly used in the printed circuit board industry for high volume fabrication of flat, highly intricate metal parts. Pen 10 is desirably formed from type 304 stainless steel, full hard, although most other 300 series stainless steels are contemplated as being suitable. Pen 10 is a relatively low-mass device only requiring a very light tapping force or simple contact with a substrate in order to dispense a sample fluid onto the substrate. The light contact forces required minimizes damage to the tip during dispensing and results in a longer-lasting dispense device.

Pen 10 is a substantially planar member having opposed first major surface 18 and second major surface 20. Pen body 16 defines a fluid reservoir 22, a dispensing tip 23, and an elongate fluid channel 24 extending therebetween. Fluid reservoir 22 and fluid channel 24 open toward first major surface 18. A fluid to be dispensed is drawn through channel tip 23 into channel 24 and reservoir 22 when loading pen 10. Pen body 16 includes the means for cooperating with a pen holding device for retaining pen 10 throughout dispensing operations. Adaptor end 14 of pen body 16 defines mounting apertures 28 and 30 and abutment shoulders 32 and 34 for cooperatively engaging a pen holding device.

Fluid channel 24 may be mechanically fabricated by cutting a groove down from reservoir 22 to strike surface 36 using a carbide cutting tool. The groove ranges from 0.001″ to 0.002″ deep, and has a 60 degree included angle. Pens of the present invention have been shown to be capable of extremely small spots, depending on how well the tip is sharpened. The groove may also be machined in by using a grinding wheel, slitting saw, coined in place with a stamping operation, or by any other method known to those skilled in the fabrication arts. Alternatively, fluid channel 24 may be etched in during the initial etching step for pen body 16. Fluid channel 24 through major surface 18, resulting in an open groove half way through the body. Pens of the present invention that have been fabricated by half etching have shown good potential for an extremely low cost, medium density pen and have given good spotting results. The groove size is currently limited to about 0.002″ to 0.003″ deep in 0.005″ material thickness. Higher resolution techniques are available including, for example, using higher quality chrome/glass photomasks and using thinner photoresists to give better results.

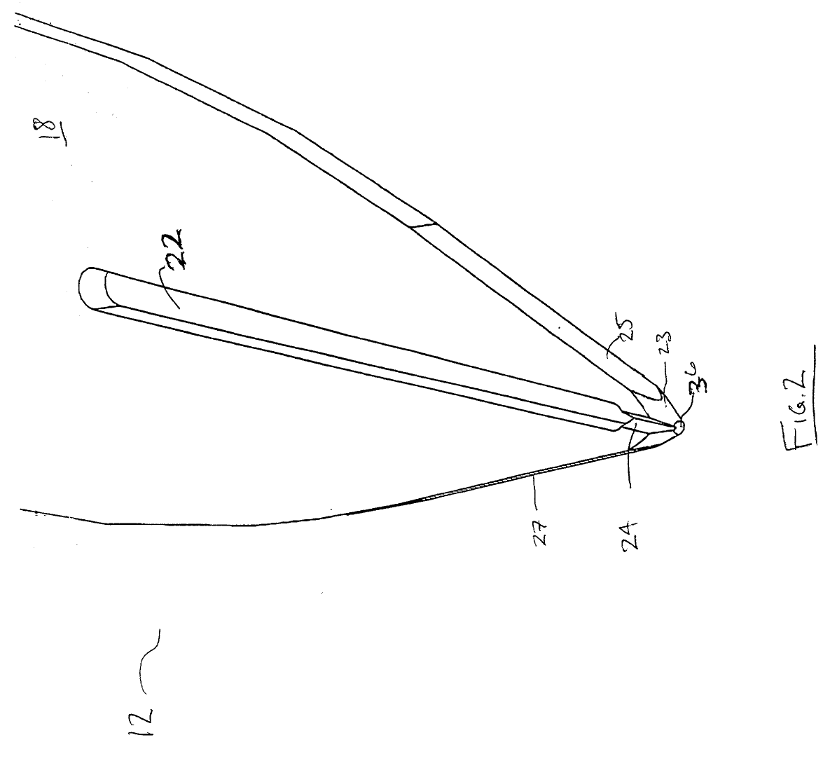

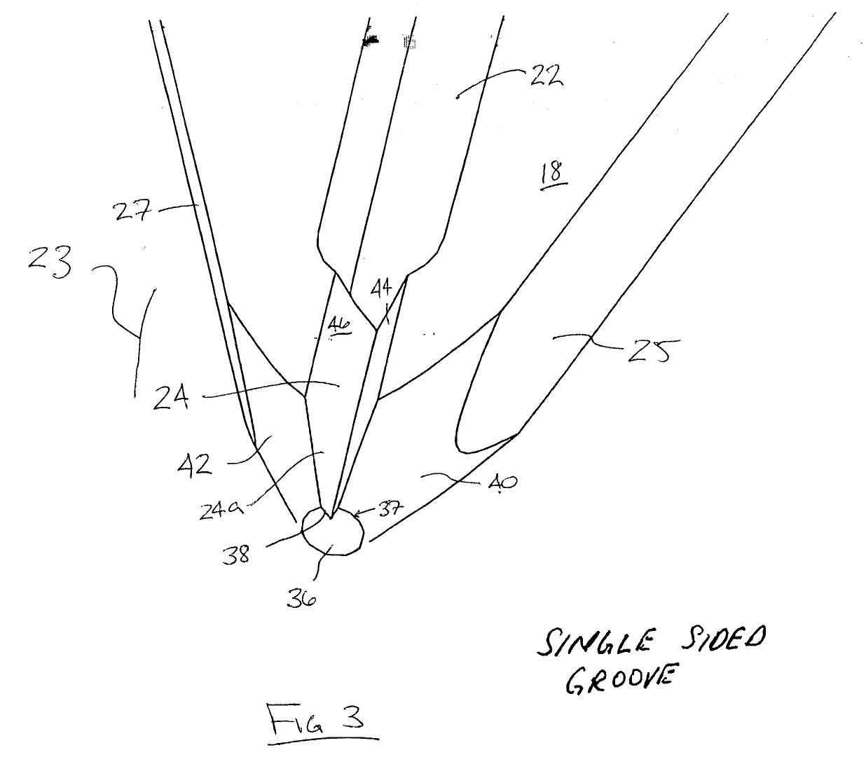

FIGS. 2 and 3 depict dispensing end 12 and dispensing tip 23 of pen 10. Dispensing tip 23 is formed between opposed tapering edges 25 and 27. Dispensing tip 23 includes strike surface 36 for striking a substrate onto which fluid is to be dispensed. Strike surface 36 is desirably formed to be planar and desirably extends substantially orthogonal to the longitudinal axis of pen body 16 so as to extend substantially parallel to the target substrate. Strike surface 36 further defines a dispense aperture 38 formed as a notch along perimetrical edge 37. Dispense aperture 38 is in fluid communication with fluid channel 24 and fluid reservoir 22. Dispensing tip 23 is lapped to a sharp conical point using 1 micron lapping paper so as to provide opposed tip surfaces 40 and 42 extending between strike surface 36 and edges 25 and 27. Tapering surfaces 40 and 42 define a tapering portion 24a of fluid channel 24. Additionally, fluid channel 24 is desirably formed between opposed channel sidewalls 44 and 46. While channel sidewalls 44 and 46 desirably define a V-shaped groove at about a sixty degree angle, the present invention contemplates other shapes for fluid channel 24 including by way of illustration and not of limitation, a U-shaped groove or a block U-shaped groove.

The material used to form a pen body of the present invention desirably exhibits good mechanical strength and corrosion resistance. The material should also etch easily so as to allow formation of the fluid conducting components of the pen as well as the mechanical retention means of adaptor end 14. The pens are desirably manufactured from type 304 stainless steel, full hard, although most other 300 series stainless steels are contemplated as being acceptable. Heat treatable stainless steels may be employed although corrosion may need to be controlled. Beryllium copper offers excellent mechanical properties for a pen of the present invention. Plating would be required for corrosion control. Titanium, Inconel and Hastelloy offer good strength and corrosion properties but are difficult to etch. These materials, as well as the previous, can be processed by laser cutting in low quantities or stamping if extremely high production quantities are required.

Pen body 10 is desirably formed to be about 0.005 inches thick, i.e. between major surfaces 18 and 20. Fluid channel 24 is desirably formed to be about 0.0015 inches across at major surface 18 and in range of about 0.001 inches to 0.003 inches deep from major surface 18. Fluid channel 24 is shown to have a V-shape although other channel shapes are contemplated by the present invention. Strike surface 26 is desirably formed to be about 0.002 inches across and has a surface area ranging from approximately 1×10^{31 7} square inches to 1×10⁻⁴ square inches. Fluid channel 24 and fluid reservoir 22 desirably hold in the range of about 5 to about 100 nanoliters and may be formed to hold about 60 nanoliters of fluid sample. The volume of fluid retained by pen 10 is desirably sufficient to deposit about 100 spots of the fluid onto a substrate between loadings. Pen 10 has demonstrated forming spots of fluid in the range of about 50 to about 500 picoliter having a diameter in the range of about 50 to about 200 microns. For present purposes, the spots of fluid dispensed by pen 10 desirably include about 100 picoliters of sample fluid having a diameter of about 120 microns. The dimensions and capacity of pen 10 are contemplated for all of the dispense pens of the present invention.

A fluid to be dispensed by pen 10 is drawn and dispensed through dispense aperture 38 and into fluid channel 24 by capillary action. Fluid drawn into fluid reservoir 22 is retained there by surface tension forces. During dispensing operations, as pen 10 is brought against a substrate or other fluid sample holding device, contact between the substrate and the sample fluid within dispense aperture 38 causes a small amount of sample fluid to form a spot on the substrate. Incremental advancement of pen 10 along the surface of the substrate between successive pen strikes allows the pen of the present invention to deposit an array of substantially uniform-sized spots of fluid sample therealong. The dispense pens of the present invention are not required to be driven against a substrate so as to break a meniscus formed by the fluid within the fluid channels. The pens of the present invention desirably only require contact with a substrate to dispense fluid from the fluid channels. The relatively light strike force required to dispense fluid from the pens of the present invention thereby causes less wear on the tip of the pen and results in a longer lasting pen with higher spot quality.

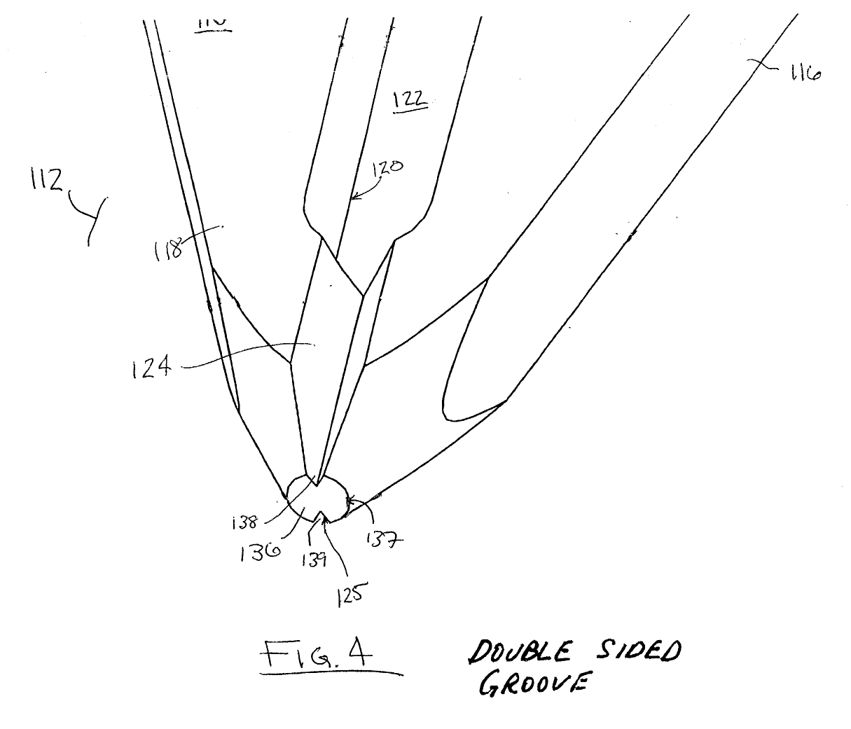

FIG. 4 depicts a dispense end 112 for a second dispense pen 110 of the present invention for dispensing sub-nanoliter volumes of a fluid sample. Dispense pen 110 is formed to be similar to dispense pen 10 and similar numbers refer to similar components. Dispense pen 110 includes a pen body 116 which defines opposed first and second fluid channels 124 and 125 opening onto substantially planar major surfaces 118 and 120, respectively. Dispense pen 110 includes a strike surface 136 which makes contact with a substrate onto which a spot of the sample fluid is to be dispensed. Strike surface 126 defines first and second fluid dispensing apertures 138 and 139, formed as opposed notches along perimetrical edge 137. Dispense apertures 138 and 139 are defined to be in fluid communication with first and second fluid channels 124 and 125, respectively, and thereby in fluid communication with fluid reservoir 122. The depths of fluid channels 124 and 125 are selected to isolate each fluid channel across pen body 16 and to maintain the structural integrity of dispense end 112.

While spotting a fluid on a substrate, dispense pen 110 has been observed to form a bead of fluid centered on strike surface 136. As dispense pen 110 is brought towards a substrate, the fluid bead is compressed between strike surface 136 and the substrate and extends over dispense apertures 138 and 139. Withdrawing dispense pen 110 from the substrate results in some fluid being deposited on the substrate while fluid is drawn from channels 124 and 125. Upon separating from the deposited spot of fluid, the fluid remaining with pen 110 again formed a bead centered on strike surface 136 and spaced from dispense apertures 138 and 139. Dispense pen 110 has thus been seen to dispense fluid without even requiring striking the substrate with the pen body. Those of ordinary skill in the art will appreciate that the geometries of the surfaces of the dispense pen of the present invention may be varied to affect the actual manner in which the dispense pen deposits spots upon a substrate. Furthermore, the interactions of the fluid with the material of either the pen body or a coating thereon may also affect the shape or location of the fluid retained by the pen while dispensing. It will be appreciated that the many variations of these parameters are contemplated by the present invention.

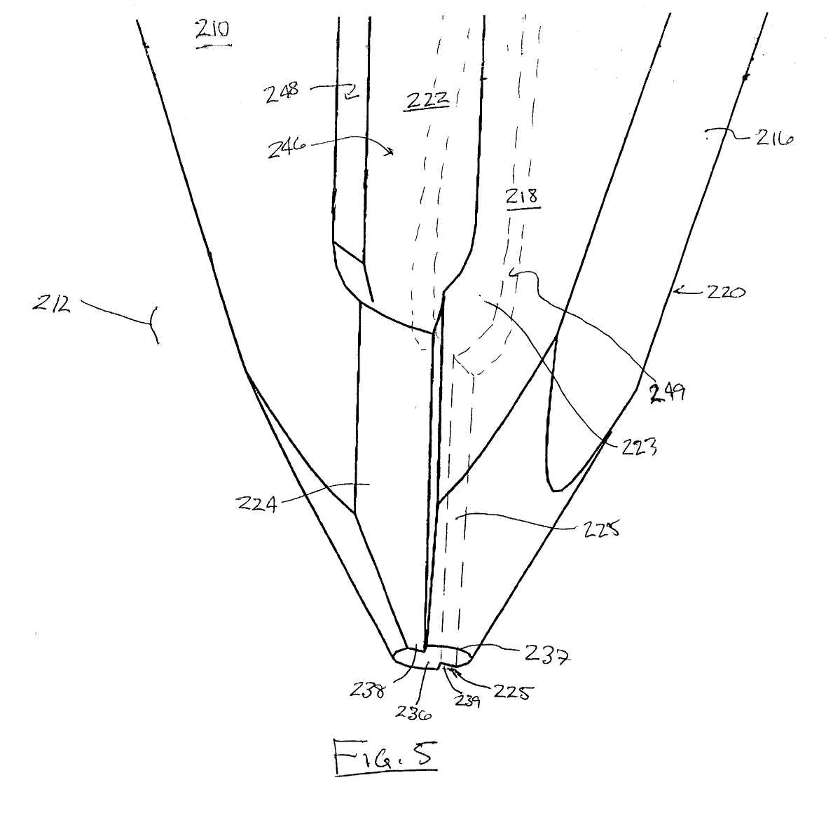

Referring now to FIG. 5, another dispense pen 210 of the present invention is presented for dispensing sub-nanoliter volumes of a fluid sample. Dispense pen 210 is formed to be similar to dispense pen 10 and similar numbers refer to similar components. Dispense pen 210 includes a pen body 216 which defines opposed first and second fluid channels 224 and 225 opening onto substantially planar major surfaces 218 and 220, respectively. Pen body 216 also defines a pair of opposed fluid reservoirs 222 and 223 opening onto major surfaces 218 and 220, respectively. Fluid reservoir 222 is in fluid communication with both fluid channel 224 and dispense aperture 238 and fluid reservoir 223 is in fluid communication with both fluid channel 225 and dispense aperture 239. Fluid reservoir 223 and fluid channel 225 are shown in phantom lines in FIG. 5. Fluid reservoirs 222 and 223 are desirably about 0.002 inches deep and are typically formed having rounded corners between the associated reservoir floor 246 and upstanding perimetrical walls 248 and 249. Dispense pen 210 includes a substantially planar strike surface 236 bounded by a perimetrical edge 237. Perimetrical edge 237 defines dispense apertures 238 and 239 which are in fluid communication with fluid channels 224 and 225, respectively. Fluid channels 224 and 225 independently wick a fluid to be dispensed through to dispense apertures 238 and 239 so as to form a single spot as dispense pen 210 is brought against a substrate.

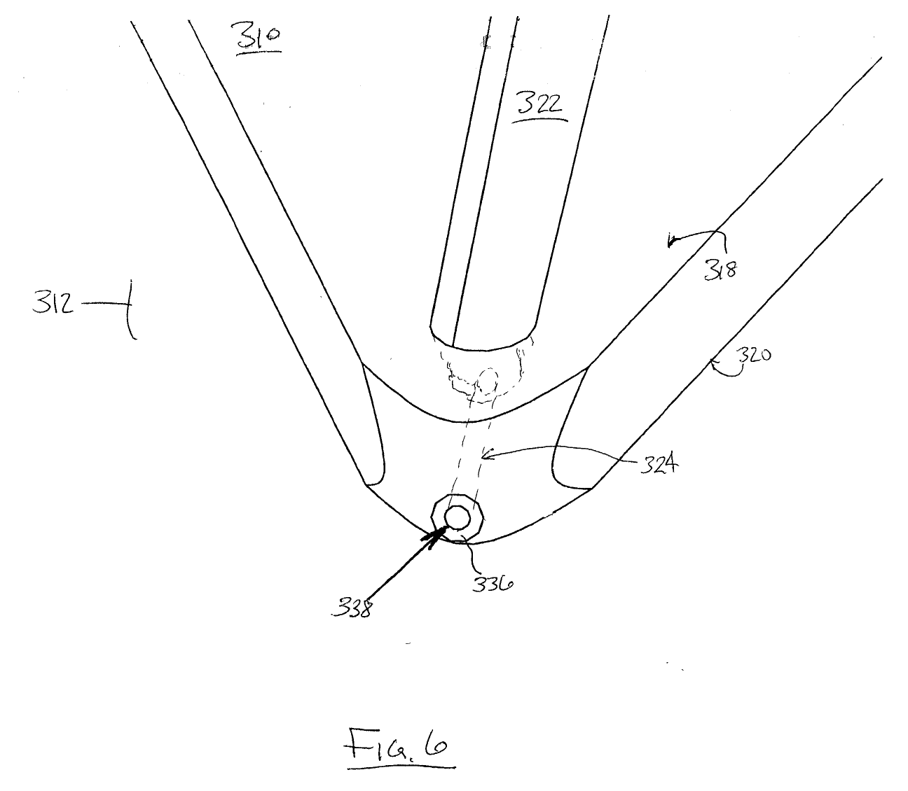

FIG. 6 depicts a dispense end 312 for another dispense pen 310 of the present invention for dispensing sub-nanoliter volumes of a fluid sample. Dispense pen 310 is formed to be similar to dispense pen 10 and similar numbers refer to similar components. Dispense pen 310 includes a pen body 316 defining a fluid reservoir 322 communicating between planar major surfaces 318 and 320. Dispense end 312 includes a substantially planar annular strike surface 336 as a rim defining a centrally-located dispense opening 338. Pen body further defines an elongate enclosed fluid channel 324 in fluid communication between dispense opening 338 and fluid reservoir 322. It is contemplated by the present invention that fluid reservoir 322 may be defined by pen body 316 to either open on one or both of major surfaces 318 and 320. Enclosed fluid channel 324 is desirably formed by mechanical drilling though strike surface 326 towards fluid reservoir 322 or by micromachining such as by electronic discharge machining (EDM).

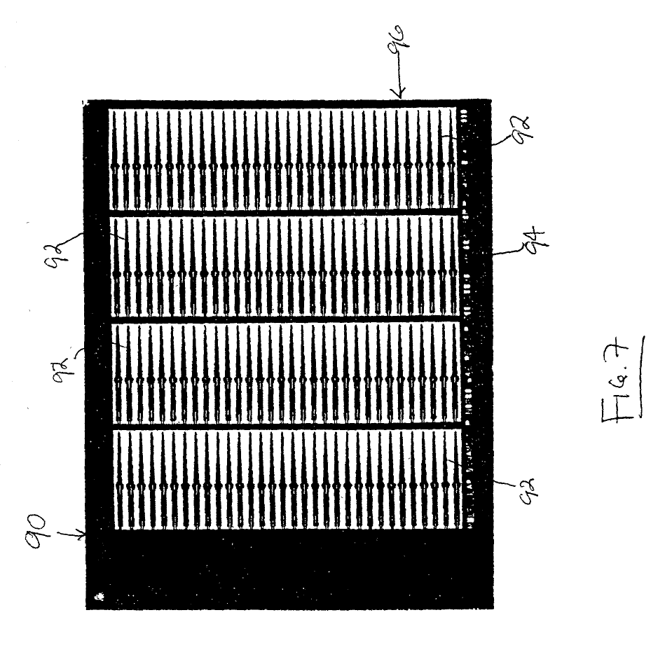

Referring now to FIG. 7, a 1 to 1 computer-generated photomask 90 used for the photochemical machining process for forming the pens of the present invention is depicted. The process for forming pens of the present invention is well-known for fabricating flat metallic components. Typically, identical pen images 92 attached to a frame image 94 of the part are nested together on a working size sheet of artwork 96, from which several hundred pens can be processed at one time on each sheet of material. The pens are fabricated using double sided etching so there is a top and a bottom photomask which are precision aligned to each other. A photoresist film is applied to both sides of material sheet 96 to be etched. The two photomasks 90 are then applied to each side of material sheet 96 and the entire structure is then exposed to ultraviolet light. The material is then dipped into a developing solution to wash away the unexposed portion of the photoresist. Sheet 110 is then run through a spray type etching machine, which chemically etches away the unprotected image, leaving behind a plurality of pen body performs, corresponding to images 92, attached to a frame, corresponding to frame image 94.

The pen bodies should be cleaned to remove any residual contaminants from the fabrication processes. This is accomplished by in an ultrasonic cleaner using 95% ethanol. It is followed by a deionized water rinse. The surface of the stainless steel should be passivated to remove imbedded surface contaminants from the fabrication process as well as to improve corrosion properties. Passivation can be accomplished by immersing the pen in a 2M solution of Potassium Hydroxide, followed by immersing in concentrated Nitric Acid. Treatment can also be accomplished with a two part solution of 2M Potassium Iodide and 20% Hydrogen Peroxide. Electropolishing using a solution of Phosphoric Acid and Sulfuric Acid and inducing an electric potential also gives excellent passivation results.

It is known that the size of the spot formed may be affected by the contact surface area of the pen tip with the substrate. This contact area can be controlled by tapering the pen tip to a sharp point using a lapping process. The tapering step should be centered symetrically about each dispense aperture as well as consistent from pen to pen to ensure uniform spotting. The contact surface is lapped smooth and flat with 1 micron lapping paper to form a uniform contact area with the substrate. Since the groove opening desirably makes physical contact with the substrate in order to draw down the liquid, any high spots that come in contact with the substrate before the groove opening should be removed during this lapping procedure.

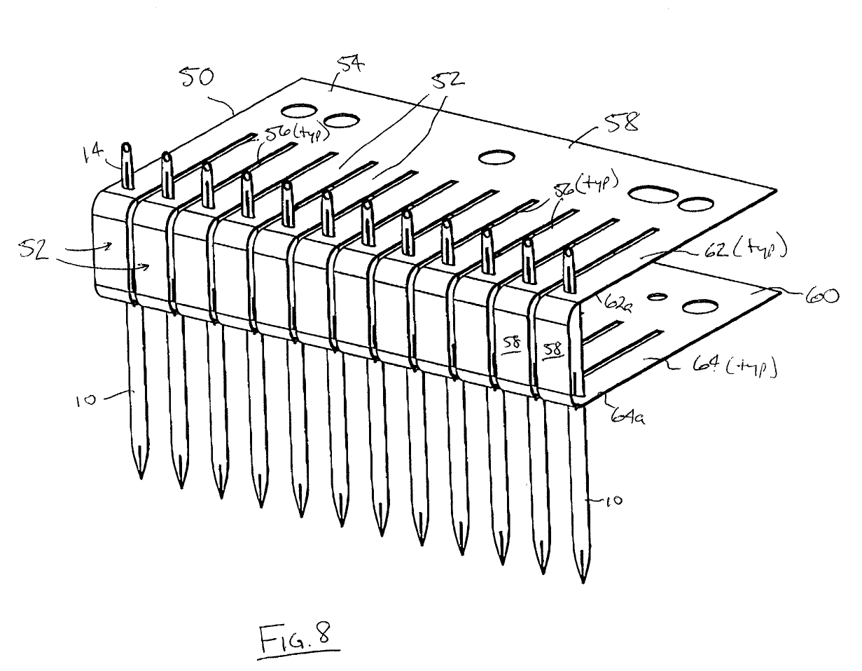

FIG. 8 depicts a cantilever twin beam flexture pen holder assembly 50 for accommodating a number of pens of dispensing pens. While FIG. 7 shows pen holder assembly 50 supporting twelve disensing pens 10 of the present invention, it is contemplated that pen holder assembly may accommodate other pen designs as well. Manifold pen holder assembly includes a number of cantilever holding arms 52, each for independently retentively supporting a dispensing pen 10.

Pen holder assembly 50 is desirably formed from a sheet metal body 54 which is cut and bent to provide an elongate slot 56 between adjacent holding arms 52. Each holding arm 52 extends between opposed first and second transversely-extending bases 58 and 60. Body 54 is bent to form, in each cantilever holding arm 52, a face 55 supporting a pair of transversely-spaced elongate beams 62 and 64 extending from face 55 to bases 58 and 60, respectively.

Each pair of beams 62 and 64 include a distal end 62a and 64a, respectively, adjacent a face 55. Each distal end 62a and 64a of each beam 62 and 64 defines a pen accommodating aperture in spaced overlying registry for receiving and retaining the adaptor end 14 of a dispense pen 10 therethrough.

Pen holder assembly 50 is retained by an applicating machine, not shown, used to dispense a sample fluid from each of the pens into an array on a substrate. The applicating machine may also control the loading of a fluid into the pens as well as the cleaning of the pens between sample loads.

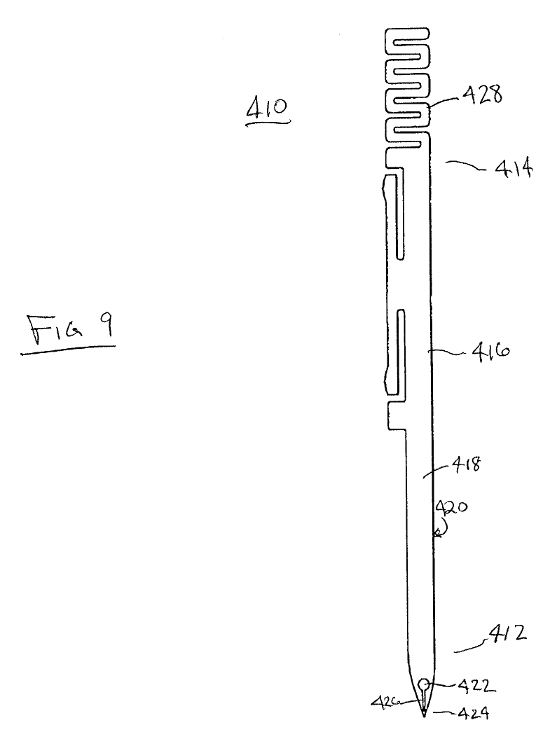

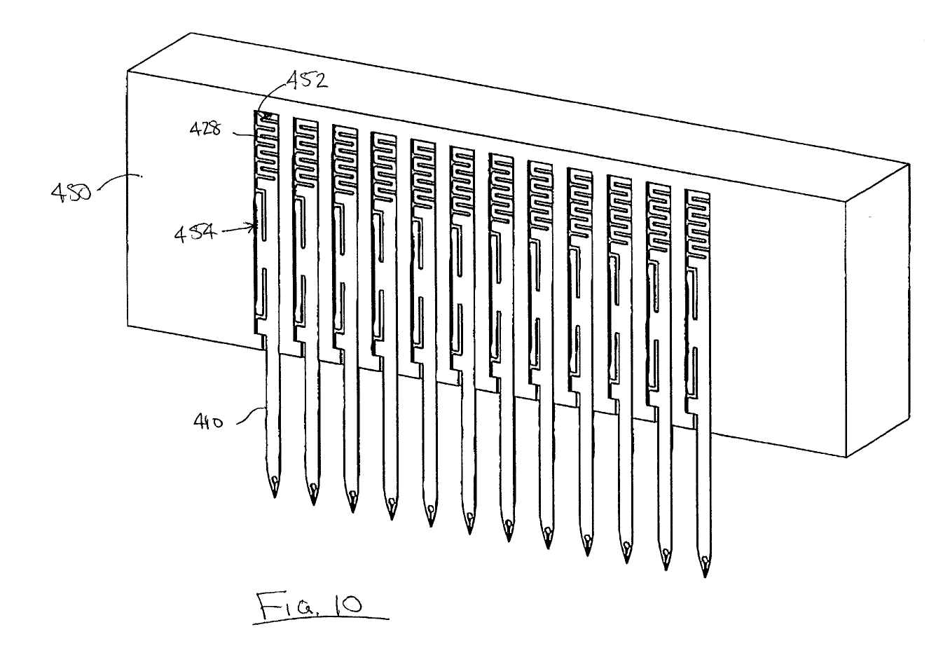

FIGS. 9 and 10 depict still another dispense pen 410 of the present invention and a pen holder assembly 450 therefor. Pen 410 includes a dispensing end 412, an opposed adaptor end 414, and an elongate pen body 416 extending therebetween. Dispense pen 410 is a substantially planar member having opposed first major surface 418 and second major surface 420. Pen body 416 defines a fluid reservoir 422, a dispensing tip 424, and an elongate fluid channel 426 extending therebetween. Fluid reservoir 422 and fluid channel 426 open toward first major surface 418. A fluid to be dispensed is drawn through dispensing tip 424 into channel 426 and reservoir 422 when loading pen 410. Pen body 416 includes the means for cooperating with a pen holding device for retaining pen 410 throughout dispensing operations. Pen body 416 defines mounting apparatus for cooperating with manifold 450. Adaptor end 414 also includes a unitary spring 428 for engaging a cooperating stop 452 at one end of a pen slot 454 defined by manifold 450.

Manifold 450 is shown to be a unitary inflexible block formed of a suitable material for holding an array of pens 410 Each pen 410 assembled into manifold 450 includes a unitary spring 428 so as to provide its own flexibility to absorb striking forces as manifold 450 is moved relative to a substrate onto which fluid is to be dispensed. The unitary springs of the assembly can therefore accommodate slight variations in the relative positioning of the dispensing tips 424 with respect to each other so as to also aid in aligning the pen tips with the substrate. It is contemplated by the present invention that the dispense ends of the pens 410 may be formed either in accordance with the teachings of the present invention or by other means known in the art. That is, the pens 410 supporting a unitary spring 428 may be formed on any pens used to dispense a fluid sample.

While the preferred embodiment of the present invention has been shown and described, it will be obvious in the art that changes and modifications may be made without departing from the teachings of the invention. The matter set forth in the foregoing description and accompanying drawings is offered by way of illustration only and not as a limitation. The actual scope of the invention is intended to be defined in the following claims when viewed in their proper perspective based on the prior art.

What is claimed is:

1. An apparatus for dispensing a liquid, comprising:
a dispensing end, an adaptor end, and an elongate dispenser body extending therebetween, said dispenser body having a first major surface extending to said dispening end, said dispenser body defining a fluid reservoir opening on said first surface, said fluid reservoir for receiving a fluid to be dispensed, said dispenser body further defining a first elongate open channel opening on said first major surface and extending between said fluid reservoir and said free end of said dispenser body.

2. The apparatus of claim 1, wherein said dispenser body includes a second major surface opposite said first major surface, said dispenser body defining a second fluid reservoir opening onto said second major surface for receiving the fluid to be dispensed and a second elongate channel extending between said second fluid reservoir and said free end of said dispenser body.

3. The apparatus of claim 1, wherein said first and second channels are shaped such that the fluid to be dispensed is conducted into said channel by capillary action

4. The apparatus of claim 3, wherein said first fluid reservoir communicates with said second fluid reservoir through said dispenser body.

5. The apparatus of claim 1, wherein said dispensing end of said dispenser body comprises a substantially planar strike surface.

6. The apparatus of claim 5, wherein said strike surface extends substantially orthogonal to the longitudinal axis of said dispenser body.

7. The apparatus of claim 5, wherein said strike surface defines a dispense end of said first channel.

8. The apparatus of claim 4, wherein said first major surface depends from said strike surface.

9. The apparatus of claim 2 wherein said first channel opposes said second channel.

10. The apparatus of claim 1, wherein said first channel is further defined between first and second elongate channel side walls.

11. The apparatus of claim 10, wherein said first and second channel side walls extend transversely-spaced across said channel.

12. The apparatus of claim 10, wherein said first and second channel side walls define a V-shape.

13. The apparatus of claim 1, wherein said free end of said dispensing body includes a non-planar strike surface.

14. The apparatus of claim 7, wherein said dispensing body further comprises a tapering surface extending between said strike surface and said first major surface.

15. The apparatus of claim 6, wherein said dispensing body is substantially planar.

16. The apparatus of claim 3, wherein said dispensing body extends between said first and second reservoirs.

17. The apparatus according to claim 3, wherein the body is approximately 0.001 inch to approximately 0.050 inches thick as measured between said first and second major surfaces.

18. The apparatus according to claim 1, wherein the contact area has a surface area ranging from approximately 1×⁻⁷ square inches to 1×10⁻⁴ square inches.

19. The apparatus according to claim 1, wherein the reservoir comprises a depressed area on the first side of the body.

20. The apparatus according to claim 1, wherein said reservoir tapers continuously to form said first channel.

21. The apparatus according to claim 1, wherein liquid is retained within the reservoir by surface tension.

22. An apparatus for dispensing a liquid, comprising:
a plurality of dispensing pens having a liquid to be dispensed upon striking each said dispensing pen upon a surface;
a dispensing pen manifold, said dispensing pen manifold including a plurality of cantilever arms for independently supporting said plurality of dispensing pens.

23. The apparatus for dispensing a liquid of claim 22, wherein each of said plurality of cantilever arms further comprises a manifold base and a pair of transversely-spaced elongate beams extending from said manifold base.

24. The apparatus for dispensing a liquid of claim 22, wherein each said cantilever arm supports a dispensing pen through at least one of said elongate beams extending from said base.

25. The apparatus for dispensing a liquid of claim 22, wherein each of said elongate beams extending from said base are adapted to support one of said dispensing pens therethrough.

26. The apparatus for dispensing a liquid of claim 22, wherein each of said first beams extend between said respective base and a common first anchor.

27. The apparatus for dispensing a liquid of claim 22, wherein each of said second beams extend between their respective base and a common second anchor.

28. The apparatus for dispensing a liquid of claim 22, wherein each of said dispensing pens further comprises a dispensing pen of claim 1.

29. An apparatus for dispensing a liquid, comprising:
an elongate dispensing body having a first free end including a strike tip, said dispensing body also defining a fluid reservoir for receiving a fluid to be dispensed and a fluid channel for conducting the fluid to be dispensed between said strike tip and said fluid reservoir.

30. The apparatus for dispensing a liquid of claim 29, wherein said strike tip includes a strike surface defining a dispense aperture in fluid communication with said fluid channel.

31. The apparatus for dispensing a liquid of claim 30, wherein said strike surface is substantially planar.

32. The apparatus for dispensing a liquid of claim 30, wherein said strike surface further comprises an annular rim about said spotting aperture.

33. The apparatus for dispensing a liquid of claim 30, wherein said strike surface is subtantially non-planar.

34. The apparatus for dispensing a liquid of claim 30, wherein said strike surface extends substantially orthogonal to the axis of the dispensing body.

35. The apparatus according to claim 1, wherein said adaptor end further comprises a unitary spring member.
